(19) United States
(12) Patent Application Publication
(10) Pub. No.: US 2020/0369303 A1
(43) Pub. Date: Nov. 26, 2020

(54) SYSTEM AND METHOD FOR DETERMINING AN ANGULAR SPEED OF AN AXLE OF A RAILWAY VEHICLE

(71) Applicant: FAIVELEY TRANSPORT ITALIA S.p.A., Piossasco (Torino) (IT)

(72) Inventors: Matteo FREA, Torino (IT); Luc IMBERT, Torino (IT)

(21) Appl. No.: 16/769,266

(22) PCT Filed: Dec. 3, 2018
(86) PCT No.: PCT/IB2018/059561

§ 371 Date: Jun. 3, 2020

(30) Foreign Application Priority Data
Dec. 4, 2017 (IT) 102017000139691

(51) Int. Cl. B61L 25/02; G01P 3/481; G01P 3/54; G01L 1/22; G01L 1/16

(52) U.S. Cl. CPC B61L 25/021; G01P 3/481; G01L 1/16; G01L 1/22; G01P 3/54

(57) ABSTRACT

A system for determining an angular speed value (Vω) of an axle of a railway vehicle is provided. The system includes a deformation detection circuit coupled to the axle of the railway vehicle, the deformation detection circuit being arranged to detect a trend over time of a flexural deformation value of the axle due to a value of a normal load exerted by the axle on the rail, and a controller to estimate the angular speed value (Vω) of the axle as a function of a frequency f derived from the trend over time of the flexural deformation value of the axle detected by the deformation detection circuit. A method for determining an angular speed value (Vω) of an axle of a railway vehicle is also provided.

### CROSS-REFERENCE TO RELATED APPLICATIONS

This application is a National Phase filing of PCT International Application No. PCT/IB2018/059561, having an International Filing Date of Dec. 3, 2018, claiming priority to Italian Patent Application No. 102017000139691, having a filing date of Dec. 4, 2017 each of which is hereby incorporated by reference in its entirety.

### FIELD OF THE INVENTION

The present invention relates, in general, to systems and sensors for monitoring the angular speed of an axle of a railway vehicle. More particularly, the present invention relates to a system and a method for determining an angular speed of an axle of a railway vehicle.

### BACKGROUND OF THE INVENTION

In known systems and methods used on board trains to measure the angular speed co of an axle, at least one toothed phonic wheel integral with the axle and a sensor adapted to detect the passage frequency of the phonic wheel teeth in front of the sensor (speed sensor) are usually provided.

The time interval between the passage of two consecutive teeth in front of the sensor may be referred to as “tooth period” (Tₜₒₒₜₕ). The number of teeth that make up the phonic wheel may be referred to as nₜₑₑₜₕ.

By multiplying Tₜₒₒₜₕ and Nₜₑₑₜₕ, the period of rotation of the phonic wheel is obtained, that is the period of rotation of the axle and wheels.

T_{wheel}=Tₜₒₒₜₕ*nₜₑₑₜₕ

The angular speed ω of the wheel is calculated starting from its rotation period by the following relation.

$${ω}_{ruot a} = \frac{2 π}{{T}_{r u o t a}}$$

Disadvantageously, such systems require dedicated (ad hoc) components used exclusively for detecting the angular speed of the axle. These components include a phonic wheel, a sensor, electronics and acquisition software, and a series of electrical wiring shielded from electromagnetic noise (noise that can distort the sensor's frequency measurement). Said components are used for the sole purpose of detecting the angular speed of the axle with consequent drawbacks in terms of costs and installation times.

Prior art teaches to install one or more strain gauges in various configurations, including the full Wheatstone bridge, “half bridge” or “quarter bridge”, on the axle and/or wheel of a railway vehicle to estimate the contact forces between the wheels and the rail, starting from the deformation of the axle.

Currently, the estimate of the wheel-rail contact forces has as its sole main objective the monitoring of the infrastructure and rolling stock and the relative scheduling of maintenance and/or correction interventions, as illustrated in the block diagram in FIG. 4.

At present, therefore, known systems and processes for installation of one or more strain gauges on the axle and/or wheel of a railway vehicle do not provide for the possibility of using the measurements made by said one or more strain gauges to determine the angular speed of the axle and, consequently, the translational speed of the vehicle.

### SUMMARY OF THE INVENTION

An object of the present invention is therefore to allow measurement of the angular speed of an axle and, consequently, calculation of the translational speed of the vehicle without using dedicated additional angular speed sensors.

In view of the above, a system for determining the angular speed of a railway vehicle axle is provided.

The system comprises a deformation detection circuit coupled to an axle of the railway vehicle. The deformation detection circuit is provided for detecting the trend over time of a flexural deformation value of the axle due to a value of normal load exerted by the axle on the rail.

The system for determining an angular speed value further comprises a controller for estimating the angular speed of the axle as a function of a frequency derived from the time trend of the flexural deformation value of the axle detected by the deformation detection circuit.

The above and other objects and advantages are achieved, according to an aspect of the present invention, by a system and a method for determining an angular speed of an axle of a railway vehicle having the features described below. Preferred embodiments of the present invention are also described.

The functional and structural features of some preferred embodiments of a system and a method for determining the angular speed of an axle of a railway vehicle according to the present invention will now be described with reference to the accompanying drawings.

### BRIEF DESCRIPTION OF THE DRAWINGS

FIG. 1 illustrates an axis of a railway vehicle to which a deformation detection circuit is coupled;

FIG. 2 illustrates by way of example the signal generated by the deformation detection circuit subjected to a flexural deformation, during movement of the train;

FIG. 3A illustrates by way of example the case in which the deformation detection circuit is located on the lower surface of the axle (lower part) and the load force produces an elongation deformation;

FIG. 3B illustrates by way of example the case in which the deformation detection circuit is located on the upper surface of the axle (upper part) and the load force produces a compression deformation; and

FIG. 4 is a block diagram illustrating the steps usually performed by the systems implemented according to the prior art.

### DETAILED DESCRIPTION

Before describing in detail a plurality of embodiments of the present invention, it should be noted that the present disclosure is not limited to the constructional details and to the configuration of the components presented in the following description or shown in the drawings. The invention may assume other embodiments and be implemented or carried out in different ways. It should also be understood that the phraseology and terminology are for descriptive purpose and are not to be construed as limiting. The use of “include” and “comprise” and variations thereof are intended as including the elements cited thereafter and their equivalents, as well as additional elements and equivalents thereof.

Furthermore, throughout the present disclosure and in the claims, the terms and expressions indicating positions and orientations, such as “longitudinal”, “transverse”, “vertical” or “horizontal”, refer to the travel direction of the train.

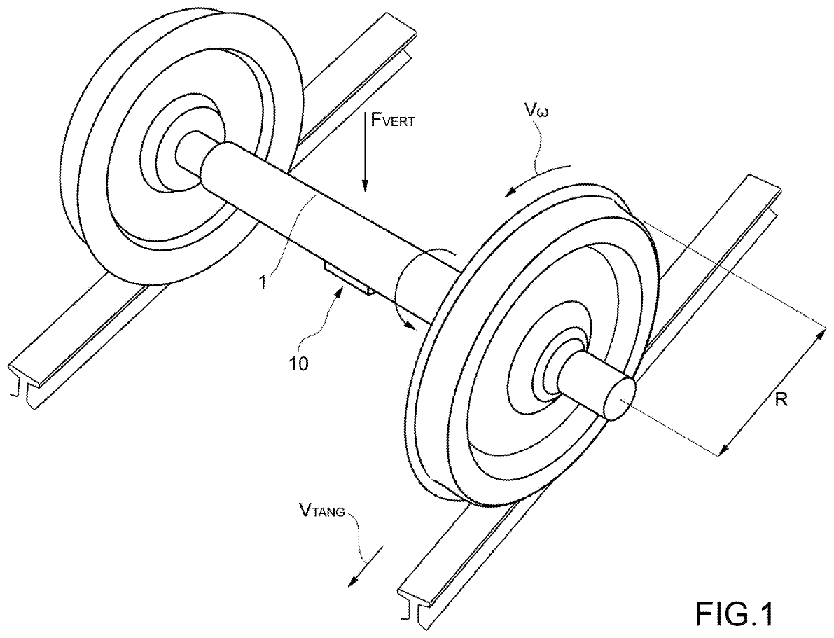

With reference initially to FIG. 1, an axle of a railway vehicle is illustrated by way of example to which a deformation detection circuit 10 is coupled, belonging to the system for determining an angular speed of a railway vehicle according to the invention.

In a first embodiment of the present invention, the system for determining an angular speed V_{ω} of an axle of a railway vehicle comprises a deformation detection circuit 10 coupled to an axle 1 of the railway vehicle.

The deformation detection circuit 10 is coupled to an axle 1 of the railway vehicle and is provided for detecting the trend over time of a flexural deformation value of the axle 1 due to a value of normal load exerted by the axle on the rail.

The system for determining an angular speed Vω of a railway vehicle further comprises a controller for estimating an angular speed value V_{ω} of the axle as a function of a frequency f derived from the trend over time of the flexural deformation value of the axle 1 detected by the deformation detection circuit 10.

Starting from the fact that two wheels having a radius R are coupled to the axle 1, said controller may be further arranged to convert said angular speed value V_{ω} of the axle into a tangential speed value V_{tang} of the railway vehicle according to the radius of the wheels R.

The formula used to estimate the angular speed V_{ω} of the axle as a function of the frequency f derived from the trend over time of the flexural deformation value of the axle 1 detected by the deformation detection circuit 10 may be the following:

V_{ω}=2*π*f

The formula used to convert said angular speed value of the axle V_{ω} into a tangential velocity value V_{tang} may be the following:

V_{tang}=V_{ω}*Radius of the wheel

The controller may be arranged in proximity to, or directly in the deformation detection circuit 10. Alternatively, the controller may be arranged remotely with respect to the deformation detection circuit 10 in control units on board the vehicle or in remote control stations with respect to the railway vehicle. Therefore, the controller may receive the data from the deformation detection circuit 10 either through a specific wiring or via a wireless connection.

The controller may be a control unit, a processor or a microcontroller.

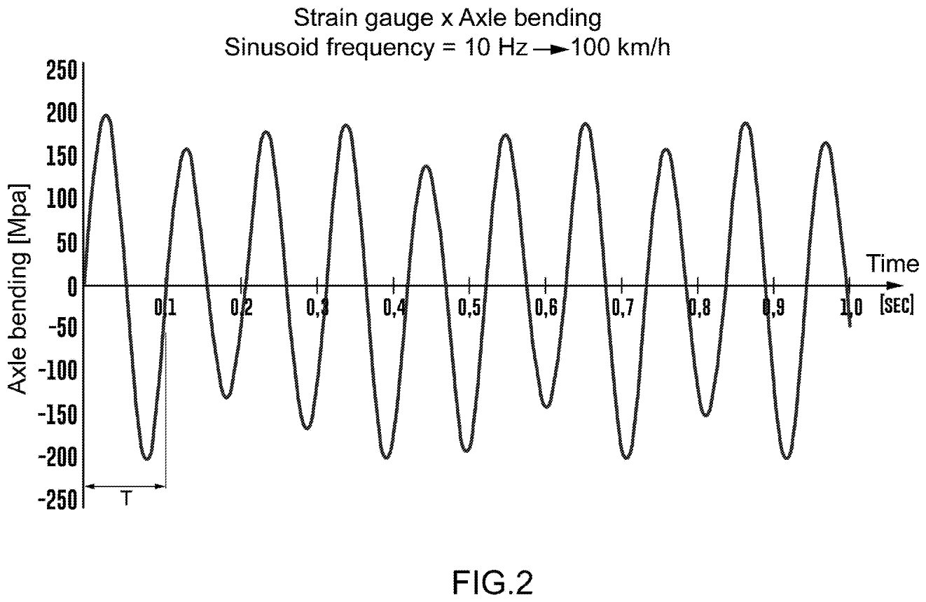

With reference to FIG. 2, starting from the signal generated by the deformation detection circuit 10 when subjected to a flexural deformation during movement of the railway vehicle, the system for determining an angular speed V_{ω} of an axle of a railway vehicle may estimate the tangential speed V_{tang} of the vehicle.

The deformation detection circuit 10 may comprise at least one strain gauge sensor and/or at least one piezoelectric sensor.

The strain gauge sensor or the piezoelectric sensor may be arranged parallel to the axle 1.

The strain gauge sensors and/or the piezoelectric sensors may be more than one, so as to increase the accuracy of the measurement.

With the vehicle stationary, the flexural deformation of the axle is correlated with the static load of the vehicle on the axle itself.

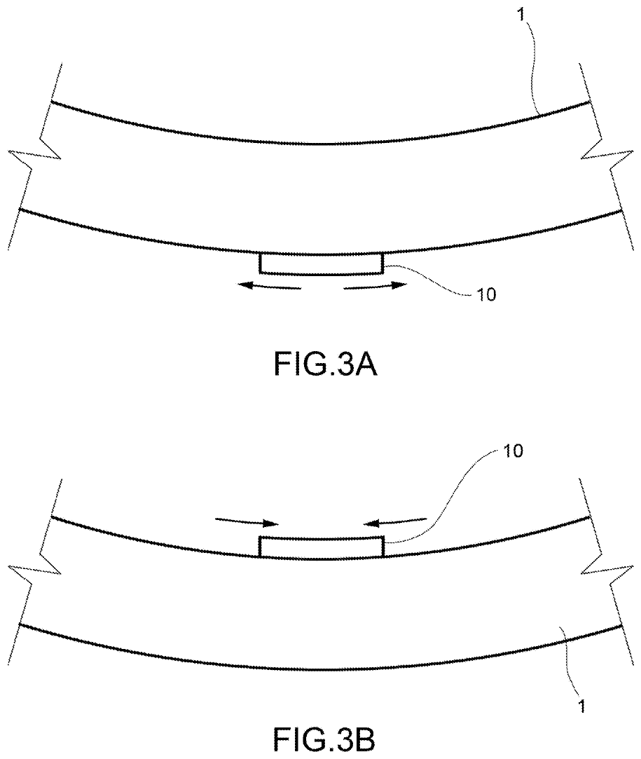

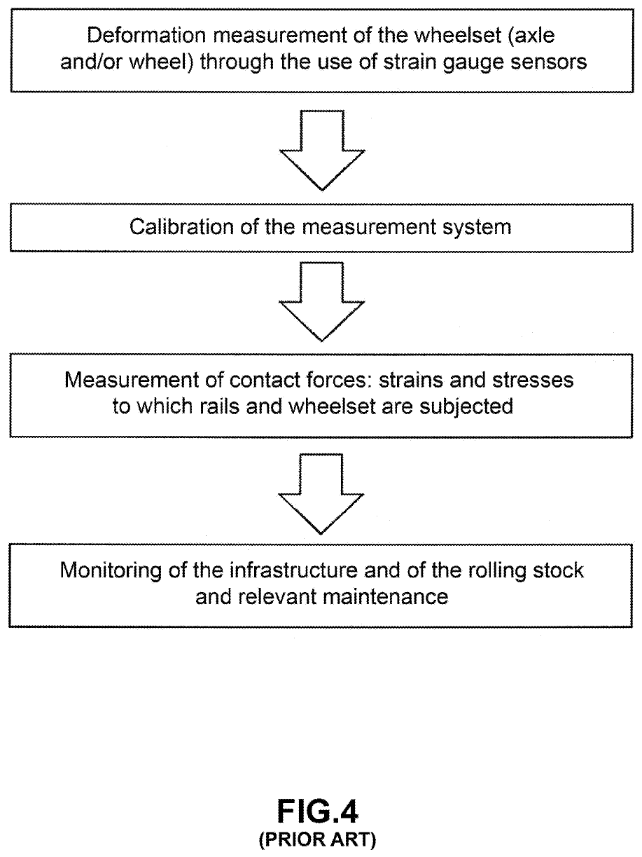

Referring to FIGS. 3A and 3B, in the case where the deformation detection circuit 10 is located on the upper surface of the axle 1 (upper part), the load force produces a compression deformation. In the case where the deformation detection circuit 10 is located on the lower surface of the axle (lower part), the load force produces an elongation deformation.

During movement of the railway vehicle, the rotation of the axle 1 will cause the deformation detection circuit 10, which is permanently associated with said axle 1, to cyclically switch position from the upper surface of the axle (upper part) to the lower surface of the axle (lower part).

During travel of the railway vehicle, the output signal from the deformation detection circuit 10 (attributable to a vertical force, Fᵥₑᵣₜ) will be of sinusoidal type with mean value equal to zero, frequency f equal to the rotation frequency of the vehicle axle and amplitude proportional to the flexural stresses to which the axle is subjected (“jolts”).

As illustrated in FIG. 2, T is an example of a period of the output signal from the deformation detection circuit 10. The frequency f will correspond to the reciprocal of the period T. This period T varies according to the speed of the railway vehicle.

The frequency f of the output signal from the deformation detection circuit 10, indicative of the time trend of the flexural deformation value of the axle 1, is the frequency f which may be used to estimate an angular speed value V_{ω} of the axle.

An elaboration of said signal may be used to estimate the angular speed V_{ω} of the axle and therefore, known the radius of the wheel, of the tangential speed V_{tang} of the railway vehicle.

In other words, the controller may be arranged to determine the tangential speed V_{tang} of the railway vehicle according to the frequency f derived from the time trend of the flexural deformation value of the axle 1 detected by the deformation detection circuit 10 and of the wheel radius R.

The present invention also relates to a method for determining an angular speed V_{ω} of an axle of a railway vehicle which comprises the steps of:
detecting a trend over time of a flexural deformation value of the axle 1 due to a value of normal load exerted by the axle on the rail; and
estimating an angular speed value V_{ω} of the axle as a function of a frequency f derived from the trend over time of the detected flexural deformation value of the axle 1.

Furthermore, starting from the assumption that on the axle 1 two wheels having a radius R are coupled, the process for determining an angular speed V_{ω} of an axle of a railway vehicle may further comprise the step of:
converting said angular speed value V_{ω} of the axle into a tangential speed value V_{tang} of the railway vehicle as a function of the radius of the wheels R.

Also with regard to the process for determining the angular speed of an axle of a railway vehicle, the formula used to estimate an angular speed value V_{ω} of the axle as a function of a frequency f derived from the trend over time of a flexural deformation value of the axle 1 detected by the deformation detection circuit 10 and the formula used to convert said angular speed value V_{ω} of the axle into a tangential speed value V_{tang} may be for example those described above for the system for the determination of an angular speed of an axle of a railway vehicle.

The advantage achieved is that of allowing, through the use of a deformation detection circuit, an estimate of the angular speed of an axle of a railway vehicle starting from flexural deformations of the axle.

Various aspects and embodiments of a system and a method for determining an angular speed V_{ω} of an axle of a railway vehicle have been described. It is to be understood that individual features shown or described for one embodiment may be combined with individual features shown or described for another embodiment. The invention, moreover, is not limited to the described embodiments, but may be varied within the scope of protection as described and claimed herein.

1. A system for determining an angular speed value (Vω) of an axle of a railway vehicle, the system comprising:
a deformation detection circuit coupled to the axle of the railway vehicle; said deformation detection circuit being arranged to detect a trend over time of a flexural deformation value of the axle due to a value of a normal load exerted by the axle on a rail;
a controller arranged to estimate the angular speed value (Vω) of the axle as a function of a frequency f derived from the trend over time of the flexural deformation value of the axle detected by the deformation detection circuit.

2. The system of claim 1, wherein two wheels having a radius (R) are coupled to the axle and said controller is further arranged to convert said angular speed value (Vω) of the axle into a tangential speed value (Vtang) of the railway vehicle according to the radius of the wheels (R).

3. The system of claim 1, wherein the formula used to estimate the angular speed value (Vω) of the axle as a function of the frequency f derived from the trend over time of the flexural deformation value of the axle detected by the deformation detection circuit is the following:
V_{ω}=2*π*f

4. The system of claim 2, wherein the formula used to convert the angular speed value (Vω) of the axle into the tangential speed value (Vtang) of the railway vehicle is the following:
V_{tang}=Vω*radius of the wheel

5. The system of claim 1, wherein the deformation detection circuit comprises at least one strain-gage sensor.

6. The system of claim 1, wherein the deformation detection circuit comprises at least one piezoelectric sensor.

7. The system of claim 5, wherein the at least one strain-gage sensor is arranged parallel to the axle.

8. A method for determining an angular speed value (Vω) of an axle of a railway vehicle, the method comprising:
detecting a trend over time of a flexural deformation value of the axle due to a value of normal load exerted by the axle on a rail;
estimating the angular speed value (Vω) of the axle as a function of a frequency f derived from the trend over time of the detected flexural deformation value of the axle.

9. The method of claim 8, wherein two wheels having a radius (R) are coupled to the axle, the method further comprising:
converting said angular speed value (Vω) of the axle into a tangential speed value (Vtang) as a function of the radius (R) of the wheels.

10. The system of claim 6, wherein the at least one piezoelectric sensor is arranged parallel to the axle.
